(19) United States
(12) Patent Application Publication
(10) Pub. No.: US 2021/0170992 A1
(43) Pub. Date: Jun. 10, 2021

(54) ASSISTANCE METHOD, COMMUNICATION DEVICE AND ASSISTANCE SYSTEM

(71) Applicant: DAIMLER AG, Stuttgart (DE)

(72) Inventors: Inés BRAUN, Ludwigsburg (DE); Manos FISCHER, Stuttgart (DE); Frank KEMPER, Stuttgart (DE); Michael KUGER, Blaustein (DE); Jakob LUICKHARDT, Stuttgart (DE)

(21) Appl. No.: 16/954,761

(22) PCT Filed: Dec. 7, 2018
(86) PCT No.: PCT/EP2018/083922

§ 371 Date: Jun. 17, 2020

(30) Foreign Application Priority Data
Dec. 18, 2017 (DE) 10 2017 011 698.9

(51) Int. Cl. B60R 25/33; G08G 1/13; B60R 25/102

(52) U.S. Cl. CPC B60R 25/33; B60R 2025/1016; B60R 25/102; G08G 1/13

(57) ABSTRACT

An assistance method involves predetermining a geographical region, within which the vehicle may move, by an authorized user of a vehicle using by means of a program on a communication device. The authorized user is informed, by the program on the communication device, when the vehicle leaves the predetermined geographical region. At least one piece of contact information for contacting an authority responsible for vehicle theft is displayed to the authorized user. A process identification feature of a process triggered by a theft display of the authorized user with the authority responsible for vehicle theft is entered into the program on the communication device and stored. A piece of positional information about a current position of the vehicle of a piece of access information to this positional information is relayed to the authority responsible for vehicle theft.

### BACKGROUND AND SUMMARY OF THE INVENTION

Exemplary embodiment of the invention relate to an assistance method, a communication device and an assistance system.

Assistance methods and assistance systems are generally known from the prior art. For example, a method for executing a function critical to safety in a vehicle is described in DE 10 2015 015 468 A1, wherein an immobilization of the vehicle, for example, is carried out as the function critical to safety. In this method, an instruction to execute the function critical to safety is sent to the vehicle. In the vehicle, an authorization for this instruction is checked. If the authorization is present, the function critical to safety is executed. The instruction and authorization are transferred from at least one unit external to the vehicle to a control device internal to the vehicle via a server external to the vehicle and a communication module internal to the vehicle, in which control device the authorization for the instruction is checked and by which control device, if the authorization is present, the function critical to safety is executed.

A method for triggering an action as part of a GeoFencing application for motor vehicles is described in DE 10 2013 007 209 A1, i.e., for triggering an action when a motor vehicle advances into a defined region of a road transport network or leaves it. The method comprises a predetermination of first limit data, which defines a limit of a first region of the road transport network, a check as to whether the condition applies, a triggering of the action when the motor vehicle advances into the first region of the road traffic network or leaves it, and if the condition does not apply, based on the first limit data, an automatic detection of second limit data, which defines a limit of a second region of the road traffic network, wherein the second limit data specifies a non-overturned, closed polygon, and the triggering of the action takes place when the motor vehicle advances into the second region of the road traffic network or leaves it.

Wireless vehicle tracking is known from DE 10 2011 005 657 A1, which discloses a vehicle tracking system comprising a remote, portable wireless device. The system also comprises a wireless transmitting/receiving device contained in each of several vehicles, wherein the wireless transmitting/receiving device is in communication with a GPS device. The system further comprises a server that can communicate both with the remote, portable wireless device and with each wireless transmitting/receiving device. The at least one server can receive several vehicle selections from the remote portable wireless device. The server can moreover determine a vehicle, which corresponds to each of the several selections, including a mobile telephone number for each determined vehicle. The server can further transmit location instructions to each determined vehicle and receive GPS coordinates from each vehicle. The server can compare the received coordinates from each vehicle and report a deviation, which goes beyond a predetermined threshold, to the remote portable wireless device.

A method for providing additional GPS vehicle position information in a tracking network of a stolen or lost vehicle for use with a vehicle is described in US 2006/0007 039 A1, which is equipped with a transmitter/receiver transponder arrangement for VHF frequency and comprises transponder-activating VHF antenna towers of a vehicle, which are controlled by a network operation control center to enable the transponder to periodically transmit vehicle-coded response signals, which can be used by a VHF direction finding vehicle in order to locate the stolen or lost vehicle. The method provides additional GPS vehicle position information via the VHF network to the direction-finding vehicle. A GPS receiver is integrated into the transmitter/receiver transponder arrangement for VHF frequency of the vehicle in such a way that, on request by the network operating center, the GPS receiver receives the GPS coordinate information about the stolen or lost vehicle on a GPS frequency at this point in time from the GPS satellite constellation. The received GPS coordinate information is provided to the transmitter/receiver transponder arrangement for the VHF frequency in order to activate this on request, which is triggered as a response to the theft or a different unauthorized movement of the stolen or lost vehicle, in order to transfer the coordinate information with the VHF frequency to the stolen or lost vehicle network together with the vehicle code. By controlling the network operation control center, an Uplink transfer of the coordinate information from the transmitter/receiver transponder arrangement for the VHF frequency of the stolen or lost vehicle to the transponder-activating VHF antenna towers of the vehicle and, from there, to the direction-finding vehicle is carried out in order to provide a starting point for the direction finding.

Exemplary embodiments of the invention are directed to an improved assistance system in comparison with the prior art.

In an assistance method according to the invention, a geographical region is predetermined by an authorized user of a vehicle, for example by a proprietor and/or authorized owner of the vehicle, by means of a program on a communication device, in particular on a mobile communication device, for example on a mobile telephone, in particular on a smartphone, within which region the vehicle may move. This does not necessarily mean that an immobilization is also carried out. Advantageously, the vehicle also continues to be mobile outside the defined zone. Such a program is also called an app (for application or application software), with an app for a mobile communication device also called a mobile app. Here, it is, in particular, a computer program product. The authorized user is informed by means of this program on the communication device when the vehicle leaves the predetermined geographical region. Then, at least one piece of information is displayed to the authorized user by means of the program on the communication device for contacting an authority responsible for vehicle theft, such that the authorized user can report a theft of the vehicle. In particular, a telephone number of a respectively nearest station is displayed. Subsequently, the authorized user obtains a process identification feature, in particular a reference, of a process triggered by this theft indication of the authorized user with the authority responsible for vehicle theft. This process identification feature is entered by the authorized user into the program on the communication device and stored, i.e., this process is stored. In order to ensure that it is a valid case and to exclude that it is being misused, a call center involved in the assistance system matches the police reference number to the responsible authority and only then relays the vehicle position. Only after this is a piece of positional information about a current position of the vehicle or a piece of access information to this positional information relayed to the authority responsible for vehicle theft.

The assistance method according to the invention makes it possible to recognize in good time, namely as soon as the vehicle leaves the predetermined geographical region, that the vehicle has been stolen. If such a theft of the vehicle is entered, the method gives aid to the authorized user in order to inform the authority responsible for vehicle theft as comprehensively as possible and to enable a quick detection of the vehicle. Here, it is displayed to the authorized user, in particular step by step, and thus in a particularly simple and comfortable manner, what is to be undertaken. They thus obtain optimal aid in an exceptional situation that is unusual for them in order to undertake everything that is necessary as soon as possible so that the vehicle can once again be detected. Furthermore, important information, in particular also the current position of the vehicle, is provided to the authority responsible for vehicle theft by means of the method according to the invention, such that a quick detection of the vehicle is made possible. Thus, the chance of detecting the vehicle is considerably improved. Here, as a result of the method according to the invention, a safe conveying of this positional information to the authority responsible for vehicle theft is in particular ensured, such that an unauthorized location of the vehicle is avoided.

In an embodiment of the assistance system, a theft report, also called a police report, with data relevant to the vehicle is compiled in addition to the display of the at least one piece of information for contacting the authority responsible for vehicle theft and displayed on the communication device by means of the program and/or relayed to the authority responsible for vehicle theft. Alternatively, the user or client can initiate or trigger the relaying. Data relevant to the vehicle is, for example, a vehicle identification number (Fahrzeug Identifizierungsnummer (FIN)), also called vehicle identification number (VIN), a motor vehicle name, a color of the vehicle, a model name of the vehicle and/or data of a SIM card installed in the vehicle subscriber identity module. Thus, a plurality of useful information for identifying the vehicle is available to the authorized user in a simple manner and without additional effort for the authorized user, which they can relay to the authority responsible for vehicle theft, or this information is automatically relayed to this authority. In this way, the detection of the vehicle is made considerably easier.

According to the invention, a piece of theft process information is transmitted to a central data store, also called server, which forms a so-called back end, by storing the process identification feature in the program of the communication device, which forms a so-called front end. There, it is stored in an electronic user file index, for example by it being forwarded to a so-called back-office tool, i.e., to a corresponding program on the central data store, with which a user assistance center works, and, there, is stored in the electronic user file index. In other words, it is stored in the central data store in an electronic user file index, and, there, is accessible via inter alia a so-called back-office tool, with which a user assistance center works. This is a reliability prerequisite for the relaying of the positioning information or the access information to this positional information to the authority responsible for vehicle theft, i.e., only then can the relaying of the positional information or the access information to this positional information to the authority responsible for vehicle theft, for example to the police, be started. Thus, a high degree of data security is achieved, and an unauthorized tracking of the vehicle is prevented.

For example, the positional information about the current position of the vehicle can be relayed by telephone or as electronic data via a corresponding communication connection to the authority responsible for vehicle theft, for example the police, for example by the user assistance center, also called the Customer Assistance Center (CAC).

In an embodiment of the assistance method, the access information to the positional information is relayed via the current position of the vehicle as an internet address, i.e., as a so-called link, to the authority responsible for vehicle theft. In this way, the authority responsible for vehicle theft can access the current positional data of the vehicle continuously, for example, such that a quick detection of the vehicle is made possible, even if it is moving. A laborious continuous consultation, for example with the user assistance center, is then not necessary.

In an embodiment of the assistance method, the positional information about the current position of the vehicle and/or the access information to this positional information and/or the relaying of the positional information and/or the access information is protected by means of a password, for example a password protected link is transmitted to the authority responsible for vehicle theft. Thus, a high degree of data security is achieved, since an access of unauthorized people is avoided.

In an embodiment of the assistance method, the access information to the positional information about the current position of the vehicle has a validity that is limited temporally and/or based on events. For example, a link, in particular password protected, with limited validity is transmitted to the authority responsible for vehicle theft, in particular the police. Thus, for example, a temporally unlimited tracking of the vehicle is avoided. Such a tracking of the vehicle is, in particular, no longer required after its detection and handover to the authorized user. The limiting event can thus be the detection of the vehicle or its handover to the authorized user. If a temporal limitation was provided and the vehicle was not detected within this temporal limitation, it can be provided, for example, that the temporal limitation is extended or a piece of access information to the positional information about the current position of the vehicle is relayed again.

A communication device according to the invention is designed and set up, in particular by means of a program, in such a way that components of this assistance system can be executed. The communication device is formed, in particular as a mobile communication device, for example a mobile telephone, in particular as a smartphone. The program is, in particular, an app (for application or application software), with an app for a mobile communication device a mobile app. The program is thus, in particular, a computer program product. The communication device with the program makes the advantages depicted above for the authorized user possible, in particular the quick recognition of a theft of the vehicle and the quick and uncomplicated introduction of the required measures for detecting the vehicle.

According to the invention, the communication device is designed and set up, in particular by means of a program, in such a way that the geographical region can be predetermined by the authorized user of the vehicle, within which region the vehicle may move, a piece of information can be emitted when the vehicle leaves the predetermined geographical region, at least one piece of information for contacting the authority responsible for vehicle theft can be displayed, and the process identification feature of the process triggered by the theft display of the authorized user with the authority responsible for vehicle theft can be entered and stored, and the theft process information can be transmitted to the central data store by storing the process identification feature. By making these method components, in particular, of the assistance method described above possible, the advantages portrayed above, in particular for the authorized user, are achieved.

An assistance system according to the invention, which is designed and set up for executing the assistance method, comprises the communication device and a position determination unit of the vehicle. The assistance method described above or at least one or more method components thereof are carried out by means of the communication device. The position determination unit, for example a so-called Windshield Unit, makes it possible to ascertain the respective current position of the vehicle, which is relayed in the manner described above to the authority responsible for vehicle theft and facilitates a quick detection of the vehicle.

According to the invention, the assistance system comprises a central data store, which is at least occasionally in communicative connection with the communication device. This central data store is used for the assistance method in the manner described above. In particular, the theft process information is stored in the electronic user file index, and the relaying of the positional information about the current position of the vehicle or the access information to this positional information to the authority responsible for vehicle theft is triggered and also carried out expediently. Furthermore, the at least one piece of information for contact with the authority responsible for vehicle theft and/or the data relevant to the vehicle is also available for the theft report from this central store and/or the theft report is compiled. Thus, the advantages portrayed above are obtained.

### BRIEF DESCRIPTION OF THE DRAWING FIGURES

Exemplary embodiments of the invention are explained in more detail below by means of drawings.

Here are schematically illustrated:

FIG. 1 an assistance system,

FIG. 2 a communication device displaying a display content of a program,

FIG. 3 a communication device displaying a further display content of a program,

FIG. 4 a communication device displaying a further display content of a program,

FIG. 5 a communication device displaying a further display content of a program,

FIG. 6 a communication device displaying a further display content of a program.

Parts corresponding to one another are provided with the same reference numerals in all Figures.

### DETAILED DESCRIPTION

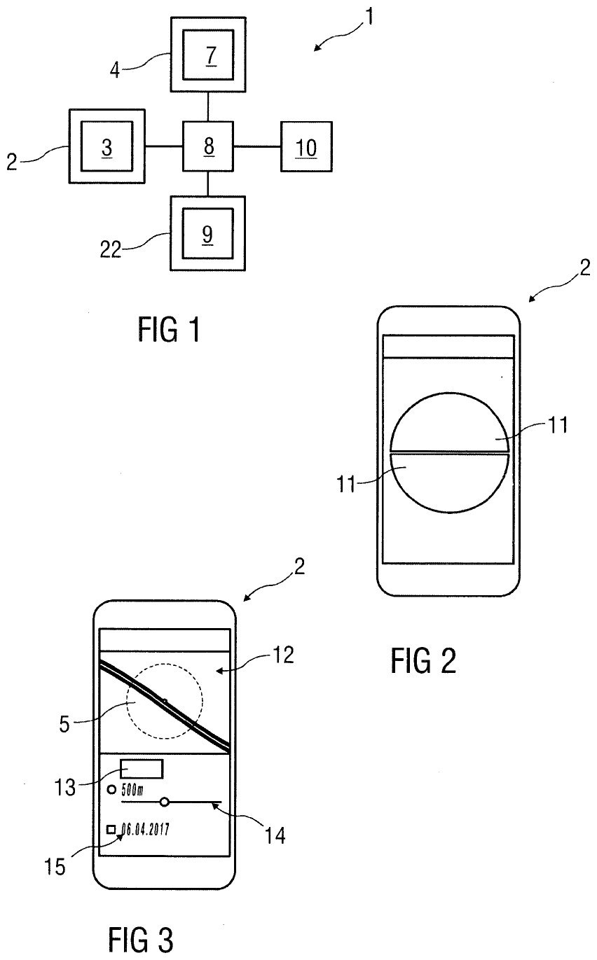

FIG. 1 shows a schematic depiction of an assistance system 1, by means of which an assistance method described below can be carried out. FIGS. 2 to 6 show a communication device 2, which has a display unit, wherein, in FIGS. 1 to 5, this display unit displays different display contents of a program 3 executed by this communication device 2, also called a computer program product. Here, the display unit is formed as a touch-sensitive display unit, which also enables inputs, i.e., it is a combined display-input unit.

This communication device 2 is advantageously a component of the assistance system 1 schematically depicted in FIG. 1, wherein at least one method component or several method components of the assistance system are executed by means of the communication device 2, in particular by means of its program 3. The communication device 2 is formed, in particular, as a mobile communication device 2, for example as a mobile telephone, in particular as a smartphone.

The program 3 is, in particular, an app (application or application software), with a mobile communication device 2, in particular a mobile app. The program 3 is thus, in particular, a computer program product.

The program 3 is available to an authorized user of a vehicle 4, for example. Various services, for example, in particular the assistance method described below, can be available to the authorized user, in particular from a vehicle manufacturer.

For the assistance method described below, the program 3, and thus the communication device 2, enables a predetermination of a geographical region 5, in which the vehicle 4 may move, also called a Geo-Fence, an activation of a theft mode, in particular when the vehicle 4 has left this predetermined geographical region 5, a display of at least one station of an authority 10 responsible for vehicle theft, in particular a police station, an access of a theft report for the authority 10 responsible for vehicle theft and/or of an insurance report for an insurance of the vehicle 4, a determination of a current position of the vehicle 4, a call function for calling the authority 10 responsible for vehicle theft, in particular the police, and/or for calling a user assistance center 22, a support of the user in the program 3, also called In-App Support, and/or a display of a user protocol 6, in particular via method components of the assistance method that have been carried out. The program 3 is protected, in particular, by a personal login of the authorized user, for example by a personal access code and/or a recognition of a fingerprint of the authorized user.

A further component of the assistance system 1 is advantageously the vehicle 4, in particular a position determination unit 7 of the vehicle 4, also called the Windshield Unit (WSU). The vehicle 4 and/or the position determination unit 7 is advantageously crosslinked, i.e., advantageously at least occasionally has a communication connection to the communication device 2 and/or to a central data store, also called the sever.

The vehicle 4 and/or the position determination unit 7 can advantageously receive, transmit, process and/or trigger commands. For the assistance method described below, the vehicle 4 and/or the position determination unit 7 enables a localization and/or positioning of the vehicle 4, i.e., in particular a position determination, i.e., a determination of a respectively current position of the vehicle 4, in particular by means of at least one global navigation satellite system.

A further component of the assistance system 1 is advantageously the central data store 8, also called the server. This stores and manages the vehicle 4, for example, i.e., information about the vehicle 4, and, for example, also information about further vehicles 4, and, for example, at least one parking position of the respective vehicle 4 and/or a status of the respective vehicle 4, in particular whether or not there has been a theft of the respective vehicle 4. Furthermore, the data store 8 stores, for example, user profiles of authorized users and links these user profiles to the respective vehicle 4. Furthermore, the data store 8 carries out security checks, for example, and can initiate commands to open and/or close a respective vehicle 4. Furthermore, the data store 8 has a “rights and roles” system for users, aid services, for example, i.e. a so-called helpdesk, developers, administrators and, where necessary, further people.

A further component of the assistance system 1 is, for example, a so-called back-office tool, i.e., a customer service program 9 of a user assistance system 22, which is installed on the data store 8 or, as shown in FIG. 1, has access to this. This enables, for example, a view of a respective electronic user file index with relevant data, in particular in relation to the respective authorized user and/or in relation to the respective vehicle 4, which the user is authorized to use. Furthermore, it enables, for example, a view of a respective vehicle location, i.e., in particular a respective current position of the vehicle 4. Furthermore, it enables, via the back-end, i.e., via the central data store 8, changes in the front-end, i.e., in the communication device 2, in particular in its program 3, for example an activation of a theft mode and/or entries in the user protocol 6.

The assistance method described below and able to be carried out by using the assistance system 1 depicted in FIG. 1, in particular by using the communication device 2 depicted in FIGS. 2 to 6, aids an authorized user of a vehicle 4 when their vehicle 4 has been stolen. In addition, this assistance method serves to recognize in good time whether the vehicle 4 was stolen. Moreover, the assistance method increases the chances of vehicle retrieval after a theft by a vehicle position, i.e., a respective current position of the vehicle 4, being communicated to a determining authority, i.e., an authority 10 responsible for vehicle theft, for example using the user assistance system 22, also called Customer Assistance Center (CAC).

To carry out the assistance method, the program 3, for example a smartphone application, is available to the authorized user. Here, this program 3 can include different services. One of these services is the assistance method. Here, the authorized user performs so-called Geo-Fence settings in the program 3, i.e., predetermines the geographical position 5 within which the vehicle 4 may move, and, in the event of theft of the vehicle 4, i.e., in particular when the vehicle 4 leaves this predetermined region, can activate the theft mode, in order to then obtain step-by-step instructions in relation to a further procedure. For this, two switching surfaces 11, for example, are displayed to the authorized user in the program 3, which they can actuate, as shown in FIG. 2. One of these switching surfaces 11 activates the setting possibilities for predetermining the geographical region 5 and the other switching surface 11 activates the theft mode.

In addition to the communication device 2 and/or to the program 3 installed thereon, an administrator portal, for example, can be provided, i.e., an internet platform, on which the authorized user has access via the internet. The authorized user of the vehicle 4, for example the vehicle owner, has access to the administrator portal after successful registration. The administrator portal allows the authorized user to manage all services. In the context of the services described here of the assistance system, the authorized user has the possibility to perform all setting and functions, which are also available via the program 3 on the communication device 2.

In order to recognize a theft of the vehicle 4 in good time, the assistance method uses the so-called “Geo-Fence”. This means that the authorized user sets the geographical region 5 in the program 3, which their vehicle 4 should not normally leave, i.e., inside which it may move. Should the geographical region 5 be left, the authorized user is immediately made aware of this.

To predetermine the geographical region 5, the authorized user opens the program 3 and chooses, for example via the corresponding switching surface 11, the setting possibilities for predetermining the geographical region 5. Now, a map 12 is displayed to the authorized user on the display unit of the communication device 2, as schematically shown in a simplified manner in FIG. 3. The authorized user can select a position or input into a search input field 13 of a search function. If they have defined the position, they can set a radius around this position, for example by means of a slide controller 14. In addition, they can also optionally set a period of time 15 for which the predetermined geographical region 5 applies. Alternatively, or in addition to the predetermination of the radius around the location, a city or federal state, for example, can be selected and predetermined as the geographical region 5.

As soon as the authorized user has stored the predetermined geographical region 5, this information is transmitted via the vehicle back-end, i.e., via the central data store 8, to the position determination unit 7, i.e., to the Windshield Unit (WSU), of the vehicle 4 and is stored there. For reasons of data protection, it is advantageously provided that a position determination signal does not leave the driving vehicle 4, which is why the comparison of the current position of the vehicle 4 to the predetermined region 5 in the vehicle 4 takes place, i.e., in the position determination unit 7 or in a different unit of the vehicle 4

A signal is transmitted only on leaving the predetermined geographical region 5, advantageously to the back-end, i.e., to the data store 8, which triggers a so-called push notification, i.e., a notification, to the front-end, i.e., to the program 3 of the communication device 2. This notification contains, for example, only the information that the vehicle 4 has left the geographical region 5 predetermined by the authorized user. This means that it is not communicated where the vehicle 4 currently is. In addition, reference is made, for example, to the fact that the authorized user should check whether their vehicle 4 is safe or stolen.

For example, for reasons of data protection, it is provided that the authorized user can only be displayed a position of the vehicle 4 when the vehicle 4 is stationary, for example in order to easily detect the parked vehicle 4 again. This also applies to the user assistance center 22, such that, when there is no theft, no constant position monitoring of the vehicle 4 can be undertaken outside the vehicle 4.

As soon as the theft mode is activated, the user assistance center 22, i.e., a respective employee of the user assistance center 22, can also view the respectively current position and thus location of the driving vehicle 4. Here, it can be provided that exclusively the user assistance system 22 and, for example, the authority 10 responsible for vehicle theft can see this positional information. This means that as soon as the theft mode is activated, for the authorized user, for example, the location view of their vehicle 4 is hidden, such that they do not obtain any positional information about their vehicle 4, neither when it is driving nor when it is stationary. Thus, it can be avoided, for example, that the authorized user themselves looks for their vehicle and, in doing so, is put at risk.

If, after they have been informed by means of the program 3 on the communication device 2 that the vehicle has left the predetermined geographical region 5, the authorized user establishes that it was in fact stolen, they open the program 3 and activate the theft mode by means of the corresponding switching surface 11 depicted in FIG. 2.

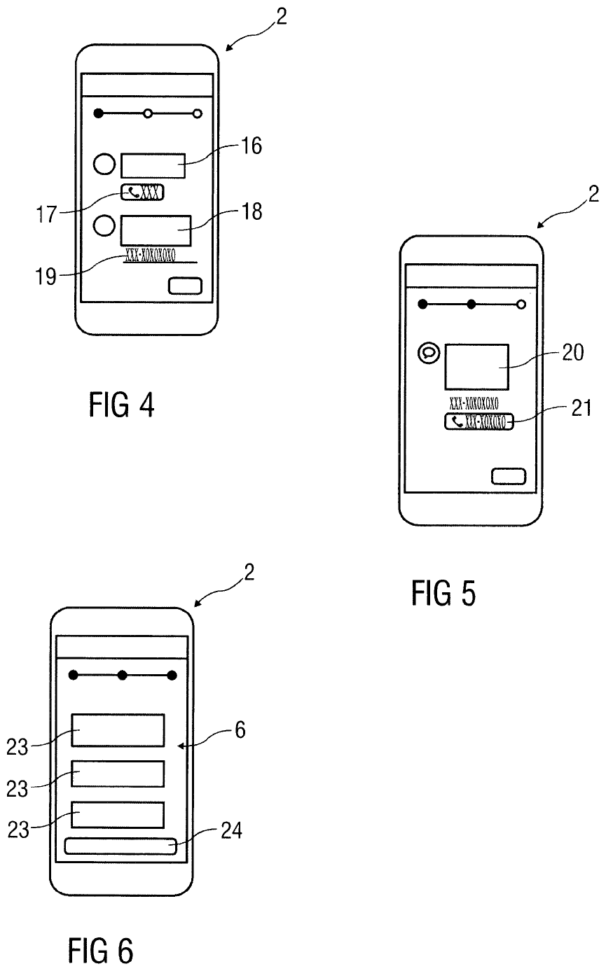

Firstly, the authorized user is shown step-by-step what they must now undertake. As a first step, in a displayed prompt field 16 it is listed out that they must submit a theft report to the authority 10 responsible for vehicle theft, for example to the police, as shown in FIG. 4. For this, the authorized user must go in person to the police station, for example, and report the theft. In addition, the authorized user obtains at least one piece of contact information 17 for contacting this authority 10, for example the police. For example, the option is given to the authorized user in the program 3 to inform the police in advance by telephone via a direct link or via the display of a telephone number. Advantageously, the program 3 additionally displays the nearest police station. For this, it employs information from a search engine, for example.

In order to simplify the theft notification for the authorized user and the authority 10 responsible for vehicle theft, for example the police, a menu of the program 3, for example, offers a theft report to download which can be produced digitally, for example, or printed out or sent by email to the authority 10 responsible for vehicle theft. The theft report contains data relevant to the vehicle, for example a vehicle identification number (Fahrzeug Identifizierungsnummer (FIN)), also called vehicle identification number (VIN), a motor vehicle name, a color of the vehicle 4, a model name of the vehicle 4 and/or data of a SIM card installed in the vehicle subscriber identity module which is exported, for example, from vehicle documentation, for example on the central data store 8. In addition, this theft report advantageously contains an indication for the authority 10 responsible for vehicle theft that a location of the vehicle 4 can be tracked and that, to do so, there is a defined process, and contains indications as to what to look out for. Furthermore, the authorized user can be informed, for example via the program 3, as to what documents they have to take with them to the authority 10 responsible for vehicle theft, for example to the police station, for example personal identification, a driving license and/or a vehicle registration document.

After the authorized user has now demonstrated the theft to the authority 10 responsible for vehicle theft, for example at the police station, they obtain a process identification feature of a process triggered by this theft demonstration from this authority 10 responsible for vehicle theft, for example a reference number in relation to this theft demonstration. In the next step, they enter this process identification feature, for example the reference number, into the program 3 and store this process, as shown in FIG. 4. For this, the program 3 displays a corresponding input request 18 and a corresponding input field 19.

With the storing in the front-end, i.e., in the communication device 2, in particular in its program 3, this information about the back-end, i.e., about the central data store 8, is forwarded to the back-office tool, i.e., to the customer service program 9, of the user assistance center 22 and stored there in the electronic customer file index. In the third step, the authorized user contacts the user assistance center 22 in order to end the activation of the theft mode. To do so, the request 20 for contacting the user assistance center 22 and its assistance telephone number 21 are displayed to the authorized user by the program 3. For example, the user assistance center 22 here requests again in which federal state the theft was reported.

Advantageously, the responsible employees in the user assistance center 22 are trained employees, who know how to specifically respond to users in stressful and exceptional situations. The employee explains to the authorized user on the telephone what steps are now being initiated and that they will be kept up to date via a protocol function of the program 3 by means of the user protocol 6 depicted in FIG. 6.

For example, some of the entries into the user protocol 6 are carried out automatically, for example when the authorized user inputs the process identification feature, for example the reference number. Other entries are initiated manually, for example, by the employee of the user assistance center 22, such as, for example, the notification that the user assistance center 22 has communicated the location, i.e., the current position, of the vehicle 4 to the authority 10 responsible for vehicle theft. FIG. 6 shows the user protocol 6 with corresponding protocol entries 23, for example in relation to the theft demonstrations carried out, in relation to the successfully activated theft mode and in relation to relaying the positional information relating to the current position of the vehicle 4 to the authority 10 responsible for vehicle theft.

There is an interface between the back-office tool of the user assistance center 22, i.e., the customer service program 9, and the vehicle back-end, i.e., the central data store 8, i.e., the customer service program 9 of the user assistance center 22 is carried out on the central data store 8 and can then correspondingly access the data of the vehicle 4 and the authorized user, in particular also the positional information about the vehicle 4, or it communicates with the central data store 8 in order to make this possible, as shown in FIG. 1.

In an embodiment of the assistance method, the authorized user additionally has the option to download all data relevant to insurance for a damage demonstration for an insurance, for example a partial coverage insurance, of the vehicle 4, for example as a PDF file or in a different form. Such an insurance report is compiled, for example, with data relevant to the vehicle from the vehicle documents and from the vehicle back-end, i.e., from the central data store 8 and contains, for example, the process identification feature, in particular the reference number, a date of the theft and/or further information. In addition, the insurance report also includes important evidence for the damage display, for example, and a checklist for this. To do so, it is depicted in FIG. 6 that the program 3 displays a compilation switching surface 24 for compiling this insurance report.

For example, in the next step, the employee of the user assistance center 22 phones a tracking coordinator in the relevant federal state. The user assistance center 22 has a list with contact data for tracking coordinators in all federal states. In order to ensure that the case is valid, the employee of the user assistance center 22 mentions the process identification feature, for example the police reference number, to the tracking coordinator, for comparison. If this matches, the employee of the user assistance center 22 may share the location of the vehicle 4, i.e., its current position, with the tracking coordinator.

In this step, the employee of the user assistance center 22 additionally communicates the case number, for example, to the authority 10 responsible for vehicle theft, for example the police, such that the user assistance center 22 can immediately allocate the case in the event of later requests by this authority 10. Moreover, the employee of the user assistance center 22 also activates the theft mode after comparison of the process identification feature, for example the reference number. This means that the authorized user sees in the program 3 that their vehicle 4 is being searched for and is also visible in the customer file in the back-office tool, i.e., in the electronic customer file in the customer service program 9.

As soon as the theft mode is active, the location of the moving vehicle 4 is enabled. This position determination unit 7 of the vehicle 4 is requested, for example by SMS, to transmit the location of the driving vehicle 4, i.e., the respectively current position of the driving vehicle 4. As soon as the theft mode is active, for the authorized user, the view of their vehicle 4 on the map 12 in the program 3 is blocked until the theft mode is deactivated.

A particular advantage of the assistance method is thus relaying the vehicle location to the authority 10 responsible for vehicle theft, in particular to the police. This can happen via telephone, for example in the manner described above. In a further embodiment of the assistance method, it is provided to enable a so-called Live-Tracking of the vehicle 4 to the authority 10 responsible for vehicle theft, i.e., a real-time display of the respective current position of the vehicle 4. This can be carried out, for example, by a password-protected link with limited validity, i.e., a piece of access information to the positional information via the current position of the vehicle 4 is relayed as an internet address to the authority 10 responsible for vehicle theft, connected, for example, to a password protection and, for example, with limited validity. Thus, the authority 10 responsible for vehicle theft receives direct access to this positional information on the central data store 8, as schematically depicted in FIG. 1.

After the location of the vehicle 4 has been communicated to the authority 10 responsible for vehicle theft, the employee of the user assistance center 22, for example, calls the authorized user back and supports them with topics such as damage display with partial coverage insurance of the user, vehicle deregistration, for example with the transport office, and with other necessary processes.

If the authority 10 responsible for vehicle theft, for example the police, does not have constant access to the positional information about the vehicle 4, it can further request the vehicle position during the search from the user assistance center 22, for example by mentioning the case number.

For example, at the end of a predetermined period of time of a month, for example, from receipt of the damage display with partial coverage insurers, the vehicle 4 passes into possession of the insurance company. If the vehicle 4 is found before the end of this deadline, it is provided, for example, that the vehicle 4 must be taken back by the authorized user. Because of this, the employee of the user assistance center 22 sets a resubmission of the case after a predetermined period of time of five weeks, for example.

If the vehicle 4 is found within a predetermined period of time of four weeks, for example, the search authority, i.e., the authority 10 responsible for vehicle theft, expediently communicates this to the employee of the user assistance center 22 in relation to the case number. They contact the authorized user and generate a new entry in the user protocol 6. Thus, a push notification, i.e., a notification, on the communication device 2 of the authorized user is advantageously additionally triggered with the indication that the vehicle 4 has been found. Furthermore, the theft mode is thus deactivated. Thus, the employee of the user assistance center 22 can close the case.

If the vehicle 4 is not found within the predetermined period of time of four weeks, for example, the employee of the user assistance center 22 advantageously phones the authority 10 responsible for the search, i.e., the authority 10 responsible for vehicle theft, for example after a further predetermined period of time of a further week, for example, in order to make sure that the vehicle 4 has actually not been found. If this is the case, they expediently deactivate the theft mode. Then, they advantageously get in touch with the authorized user in order to communicate to them that the case is closed and thus their vehicle 4 is separated from the electronic user file.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in anyway. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-7. (canceled)

8. An assistance method, comprising:
predetermining, by an authorised user of a vehicle via a program executing on a communication device, a geographical region within which the vehicle may move;
informing, via the program executing on the communication device, the authorised user when the vehicle leaves the predetermined geographical region;
displaying, via the program executing on the communication device, at least one piece of contact information for contacting an authority responsible for vehicle theft;
entering into the program on the communication device a process identification feature of a process triggered by a theft display of the authorised user with the authority responsible for vehicle theft;
storing the process identification feature on the communication device;
relaying, a piece of positional information about a current position of the vehicle or a piece of access information to the positional information, to the authority responsible for vehicle theft,
wherein, by storing the process identification feature, a piece of theft process information is transmitted to a central data store and is stored in the central data store in an electronic user file, and
wherein the storage of the piece of theft process information is a reliability requirement for relaying the positional information or the access information to the positional information to the authority responsible for vehicle theft.

9. The assistance method of claim 8, wherein in addition to the display of the at least one piece of contact information for contacting the authority responsible for vehicle theft, a theft report with data relevant to the vehicle is compiled and displayed by the program on the communication device or is relayed to the authority responsible for vehicle theft.

10. The assistance method of claim 8, wherein the access information to positional information about the current position of the vehicle is relayed as an internet address to the authority responsible for vehicle theft.

11. The assistance method of claim 10, wherein the positional information about the current position of the vehicle, the access information to positional information, the relaying the positional information or the access information is protected by a password.

12. The assistance method of claim 10, wherein the access information to positional information about the current position of the vehicle has a validity that is temporally limited or limited based on events.

13. A communication device, comprising:
a mobile application, which when executed by the communication device causes the communication device to
predetermine a geographical region by an authorised user of a vehicle within which the vehicle may move;
emit a piece of information when the vehicle leaves the predetermined geographical region;
display at least one piece of contact information for contacting an authority responsible for vehicle theft;
enter and store a process identification feature of a process triggered by a theft display of the authorised user with the authority responsible for vehicle theft; and
transmit theft process information by storing the process identification feature to a central data store.

14. An assistance system, comprising:
a central data store;
a position determination unit of a vehicle; and
a communication device comprising a mobile application, which when executed by the communication device causes the communication device to
predetermine a geographical region by an authorised user of a vehicle within which the vehicle may move;
emit a piece of information when the vehicle leaves the predetermined geographical region;
display at least one piece of contact information for contacting an authority responsible for vehicle theft;
enter and store a process identification feature of a process triggered by a theft display of the authorised user with the authority responsible for vehicle theft; and
transmit theft process information by storing the process identification feature to the central data store;
wherein the central data store is at least occasionally in communicative connection with the communication device.
